(19) United States
(12) Patent Application Publication
(10) Pub. No.: US 2016/0236077 A1
(43) Pub. Date: Aug. 18, 2016

(54) METHOD AND SYSTEM FOR AUTOMATIC DISTRIBUTION AND SOLUTION OF TASKS

(71) Applicant: Technische Universitaet Muenchen, Muenchen (DE)

(72) Inventors: Maximilian Baust, Riemerling (DE); Christoph Hennersperger, Muenchen (DE); Nassir Navab, Muenchen (DE)

(21) Appl. No.: 14/624,407

(22) Filed: Feb. 17, 2015

(51) Int. Cl. A63F 13/23; A63F 13/52; A63F 13/31; H04L 29/06

(52) U.S. Cl. CPC A63F 13/23; H04L 67/38; A63F 13/52; A63F 13/31

(57) ABSTRACT

A method for distributing tasks includes selecting at least one interactive process according to at least one task and transferring input data related to the at least one task to at least one server associated with the at least one interactive process. The input data is to be distributed to one or more clients configured to execute entities of the at least one interactive process. The method further includes collecting, from the at least one server associated with the at least one interactive process, one or more results of processing of respective entities of the at least one interactive process based on the input data on the one or more clients, and providing output data for the at least one task based on the collected one or more results.

### TECHNICAL FIELD

The present disclosure relates to methods and systems for distributing and solving tasks, and apparatuses for providing tasks and related data. In particular, the present disclosure may relate to a distributed solution of tasks which are embedded into existing interactive processes.

### BACKGROUND

Recent increase in processing and storage capabilities enable processing of complex tasks related to large amount of data. However, solutions of such complex tasks on dedicated processing entities may be expensive and may take a long time, which could be impractical or unsuitable. For example, analysis, processing, and labeling of voluminous image data, sequences of genes or structures of proteins often cannot be accomplished by a single processing entity within an acceptable period of time due to the amount of data and complexity of the task.

Recently, crowdsourcing approaches have been proposed, where needed services or content is obtained by soliciting contributions from an online community of a large group of people, rather than from individual workers. Hence, tedious work can be subdivided between entities of the online community, where each entity may add a small portion to generate a greater result reflecting the needed service or content.

Generic approaches for crowdsourcing enable users to announce various kinds of tasks to a huge amount of available workers via respective platforms and receive work results of completed tasks from the online community. One example of such a platform is the Mechanical Turk marketplace by Amazon.com, Inc. Generic approaches require an explicit definition of tasks that are directly offered for solution by individual human workers. The human workers have to provide respective resources and knowledge in order to solve the explicitly defined task.

Further approaches to crowdsourcing of complex tasks attempt to provide tasks to the online community in a more entertaining way, such as via a game, which does not require additional resources or explicit knowledge in order to provide a solution. For example, in the areas of genetic research or protein research, the online community can contribute to solutions directed at folding proteins or identifying genes by playing specific games. Examples include the “Foldit” project by the University of Washington and the “Play to Cure” project developed by Cancer Research UK. The games are typically hard-coded and represent a fixed task within a fixed environment.

### SUMMARY AND INITIAL DISCLOSURE

What is needed is a flexible approach for an automated distribution and solution of tasks based on crowdsourcing concepts, which exploits an existing infrastructure and allows for a convenient completion of tasks.

The above issues are solved by a method and a system for distributing tasks and a respective apparatus according to the independent claims. Preferred embodiments are defined in the corresponding dependent claims.

According to a first aspect of the present disclosure, a method for distributing tasks is provided, the method comprising selecting at least one interactive process according to at least one task, transferring input data related to the at least one task to at least one server associated with the at least one interactive process, the input data to be distributed to one or more clients configured to execute entities of the at least one interactive process, collecting from the at least one server associated with the interactive process one or more results of processing of respective entities of the at least one interactive process based on the input data on the one or more clients, and providing output data for the at least one task based on the collected one or more results.

The method allows for an automated and flexible solution of tasks by embedding tasks and respective input data into existing interactive processes that are provided to and executed on individual clients. The tasks may represent problems related to data, which can be solved by interactive processing, such as interaction of a human operator with a computing device. Preferably, the tasks are related to analysis and/or processing of data, for example medical data or non-medical data, such as one or more of computer vision, image processing and pattern recognition tasks. Yet, according to the present disclosure, the tasks are not directly processed and solved on individual clients, but embedded and/or integrated into existing interactive processes, which are offered via respective servers associated with providers of interactive processes and executed on individual clients individually or connected to a respective server of the provider of the interactive process. Hence, the tasks may be at least partially solved as a by-product of execution of the interactive process configured with respective input data related to the task.

The at least one interactive process may be selected from a plurality of existing interactive processes. The interactive processes may relate to any kind of executable code, which is provided by a provider or supplier and which can be executed on individual clients. Hence, the interactive process may represent code, software or a software product. Preferably, at least some of the interactive processes are game applications or entertainment applications. Accordingly, the tasks may be embedded into existing game or entertainment concepts. The application of game concepts and technology in non-game contexts could also be referred to as gamification.

The provider or supplier of the interactive process may be any kind of entity publishing or offering access to interactive processes. For example, a cloud environment, a social network, a gaming network, a game developer or a game publisher may provide access to one or more interactive processes, which may represent individual applications or games of the respective provider or supplier. The access to individual interactive processes may be mediated by one or more servers associated with at least one of the interactive processes, which may accept input data compliant with a respective interactive process and forward the input data to at least some of the one or more clients to execute a respective entity of the interactive process. The one or more servers may be run by the provider or supplier of the interactive process and may represent one or more servers of the provider or supplier of the interactive process. Accordingly, the input data related to the at least one task may be transferred to the server of the provider of the selected interactive process for distribution to respective clients. However, it is to be understood, that the server associated with the interactive process can also be set up, maintained and run separately from a provider of the interactive process. Furthermore, it is to be understood that the input data can also be transferred to one or more servers associated with the interactive process or one or more servers of providers of the interactive process for respective distribution.

Preferably, a plurality of interactive processes can be selected according to one task and respective input data may be transferred to at least one server associated with the at least one of the plurality of interactive processes or to the at least one server of at least one provider of at least one of the interactive processes.

The interactive process of a provider or supplier may be executed on respective clients as an entity of the interactive process. The entity may correspond to an instance of executable code on the client, a copy of a software or software product, which may be installed on the client, or the like. Each client, which may also be referred to as a client device throughout this description, may represent a computing device or a processing resource on a computing device, which may be at least temporarily connected to the server via a network. For example, a client may be a personal computer, a laptop, a tablet, a game console, a set-top box, a mobile device, a smartphone, a smart TV, or any other electronic device capable of executing an entity of an interactive process and receiving input data in order to configure the entity of the interactive process. For example, the client may be a game console or a smartphone executing a game application. A user may operate the client and provide input in response to execution of the interactive process. However, since the configuration of the interactive process using the input data preferably does not modify the usual workflow or mode of operation of the interactive process, the users need not to be aware of the fact that they contribute to a solution of the task. Hence, the tasks may be transparently embedded or integrated into existing interactive processes and may exploit the existing functionality and usability of the interactive processes as well as an existing community of users of the interactive processes. With regard to a preferred use of games and/or entertainment applications as interactive processes, the approach may also relate to the concept of playsourcing, wherein contributions from a community of game players are used to solve tasks.

The input data may represent one or more sub-tasks, wherein each client of the one or more clients may be configured to solve a respective one of the sub-tasks. Accordingly, each client may receive different input data related to the task. However, the input data may also be distributed to a plurality of clients in order to receive a variety of solutions for the same task or sub-task and the same data. The server may gather the results of processing of respective entities of the interactive processes on individual clients. The server may receive a result as soon as an execution of an entity of the interactive process or a respective part of the interactive process has been completed on a client, such as closing an entertainment application on a client or completing a level of a game. During execution of the interactive process, the client may track interactions and input of the user and transmit respective data to the server. Additionally or as an alternative, the client may pre-process the tracked data and/or use further data generated by the interactive process as results of execution of the interactive process, which are transmitted to the server. Furthermore, the results of processing of respective entities of the interactive process based on the input data may also relate to one or more results on at least some of the one or more clients. Hence, the results may be collected at a particular point in time and entities which have not concluded processing may be disregarded for the output data.

The approach according to the present disclosure enables a use of existing and established interactive processes, such as games or entertainment applications, for solution of tasks. Hence, the approach facilitates reusability of established concepts and does not require development of dedicated interactive processes for specific tasks. Furthermore, the approach may take advantage of existing and established platforms and communities of users of interactive processes for solution of individual tasks. For example, a community of game players of an established gaming platform playing existing games may be transparently involved in solution of tasks.

The interactive processes may be applications or programs which the users like to utilize or which they conveniently use in daily work or during leisure time. For example, the interactive processes may refer to popular entertainment or networking applications, successful games, game concepts and genres, which users like to employ or play. This may ensure that enough users are available and motivated to execute respective interactive processes, and that users are executing the interactive processes even when no tasks or related data are currently to be processed, thereby keeping the community of users alive and active.

The embedding of tasks into existing and established interactive concepts for interactive processes and respective user networks defines an abstraction level, which enables a fast automatic solution of tasks by a plurality of users without incurring additional costs.

According to one embodiment, the method further comprises receiving the at least one task and a related set of data, and transforming at least a part of the set of data into respective input data compliant with one of the at least one selected interactive process. Each interactive process may specify a type or format of data which can be used to configure the interactive process for execution, such as input data which can be directly read and processed by the interactive process. The data of the set of data may have any suitable format independent of a format required by the interactive processes. For example, the set of data may correspond to one or more of sensor data, image data, acoustic data, descriptive data or any other suitable data to be analyzed and/or processed according to the task, in any combination. The set of data may also include a series of individual data, wherein each piece of the series can be individually analyzed and/or processed according to the respective task. For example, the set of data may include one or more images, one or more audio samples, or one or more video frames. Accordingly, the set of data or each piece of the set of data can be transferred into a different format which can be processed by the interactive process. For example, the interactive process may read image data and convert the data to textures, audio data to sound samples and/or further parameters to configure individual elements within the interactive process, such as geometric objects, elements of a user interface and the like. Hence, the set of data or each piece of the set of data may be transformed using a transformation function into a target format compliant with the selected interactive process. The transformation function can be any mathematical function or a set of rules transforming input data into a suitable output. For example, an input image according to the set of data can be transformed into a different coordinate system, for example resampled according to a polar grid, or various signal processing functions can be applied, such as frequency transformations. Preferably, said transforming includes transforming data from an image format, such as a medical or non-medical image format, into a native game format for an interactive process representing a game application. The image data may include one or multi-dimensional image data, such as 1 D, 2D, 3D image data with or without a time dimension.

In one embodiment, said transforming includes anonymizing the set of data. The set of data may include personal data or data allowing for a determination of a person to which the data is related. For example, the set of data may include identification data or a watermark, such as a user or patient id. The transform function may remove any data from the original set of data which could be used to identify an individual. However, it is to be understood that the set of data may already be anonymous. Hence, in the case of tasks directed at medical information, it could be guaranteed that no medical information leaves the environment of the task provider. Accordingly, said anonymizing may further include checking whether the set of data includes any personal data or data allowing for a determination of a person to which the data is related and informing the task provider in case the set of data includes personal data or data allowing for determination of a person to which the data is related. Hence, the task provider could be warned if the set of data related to the task includes unanonymized data information.

In yet another embodiment, the method further comprises automatically determining a category of the at least one task, wherein the at least one interactive process is selected according to the determined category. The categories could be, for example, related to computer vision, image processing or pattern recognition tasks and sub-tasks, which could comprise, but are not restricted to, edge detection, detection of correspondences, image segmentation, object detection, classification of textures, objects or scenes, optical flow estimation, depth estimation, 3D reconstruction and other tasks as well as combinations thereof. However, it is to be understood that other tasks and sub-tasks in different fields, such as audio or signal analysis and/or processing can be used to define respective categories of tasks. Each category of tasks may further specify valid input data or at least one or more formats of intermediate data to which a set of data related to a task of the category has to be transformed for further processing.

In one embodiment, the method further comprises querying a data base including entries, each entry specifying at least one category of tasks and at least one interactive process capable of handling tasks of the at least one category. A query of the data base may include a determined category of a task and may provide one or more interactive processes capable of handling the task. The entries may further comprise indications for transforming data such that it can be processed by a respective interactive process. For example, the entries may comprise information about a (target) format of input data compliant with the interactive processes, which can be used to transform the set of data or pieces of the set of data related to the task into the target format of the interactive processes, for example, by using the intermediate format for the category of the task. For example, a query directed at a task in an image segmentation category could lead to a plurality of results, which could, for example, indicate a variety of arcade games, wherein each resulting entry may specify parameters of textures that may be used within the arcade game to accomplish the image segmentation task. Furthermore, the entries may include indications, how tasks of a particular category can be embedded into the concept of the resulting interactive processes, such as by mapping tasks to actions or activities within the interactive process.

According to another embodiment, the interactive process is selected based on available resources. Respective resources may comprise a number of interactive processes for a category of tasks, which may correspond to a number of interactive processes for a similar concept, a number of clients, processing resources of the available clients, available bandwidth and the like. Preferably, the available resources are based on a category and/or a number of available clients for executing entities of the interactive process. Processing resources of the clients may further include the category of a client or client device. For example, a client device corresponding to a smartphone, which may enable pre-processing of low complexity, could be compared with a game console with more powerful resources. Each server distributing the input data and/or a provider of an interactive process may monitor the number of available clients, such as a number of registered users utilizing the interactive process, a number of online clients, or a number of clients currently executing an entity of the interactive process, and provide respective data. Hence, available resources can be used to select the interactive process or a category of the interactive process. Furthermore, available resources can also be used to select, identify and prioritize individual clients of the one or more clients for distribution and processing of the interactive process based on the input data. The selection of interactive processes based on resources can be used to balance the processing and solution of individual tasks or solutions directed at pieces of data related to the tasks.

In yet another embodiment, the interactive process is selected based on a level of quality of results of comparable tasks previously processed by entities of the interactive process. The method may determine a level of quality of results related to a particular interactive process or individual clients having conducted the respective interactive process at least once by monitoring and analyzing the output data for individual tasks and/or by receiving further quality data from individual task providers. These quality metrics may be classified according to task categories and individualized with regard to available interactive processes or even individual clients. Accordingly, quality metrics may be used to select an interactive process or a concept of an interactive process. Furthermore, quality metrics can be used to identify and prioritize individual clients for distribution of the input data and respective execution of the interactive process based on the input data. For example, an individual client or a client device providing results of a high quality can be identified and input data related to time or quality critical tasks could be assigned to the preferred client. Hence, time or quality critical tasks could be assigned to clients whose results meet certain quality criteria.

Preferably, the selection of the at least one interactive process may be completely automatic by selecting one or more most suitable interactive processes, such as an interactive process having a highest number of available clients and/or a highest level of quality of previous results in the same category and/or any other suitable metric. Furthermore, the selection process may be semi-automatic, wherein the retrieved interactive processes capable of handling the task can be provided to the task provider, who may then select a most suitable candidate for embedding the task. Furthermore, it is to be understood that further to a selection of at least one interactive process or a concept of an interactive process, individual clients providing better resource characteristics and meeting certain quality criteria can be identified as preferred clients for distribution of the input data by the server.

According to a further embodiment, the method comprises transforming the collected one or more results back into a format compliant with the at least one task and providing the transformed results as the output data of the at least one task. The transformation of the results may be an inverse transformation with regard to the transformation of the set of data related to the task and may be accomplished using an inverse transform function in order to transform the results into a format compliant with the original set of data of the task. For example, if the original set of data was transformed using a frequency transformation or a transformation of the coordinate system, the inverse transformation may correspond to the inverse frequency transformation or an inverse transformation of the coordinate system. Hence, the characteristics of the output data may directly correspond to characteristics of the original set of data. Accordingly, the task provider can directly handle the output data and needs not to have any knowledge of the actual interactive process that has processed the set of data or pieces of the set of data. Furthermore, pieces of the set of data can be processed using various interactive processes on various clients and a respective back transformation enables a comparability of the results with regard to the original set of data. Preferably, the method further comprises merging the collected one or more results into a single result. The results may be merged, for example, by employing statistical or model-based approaches. Hence, the results can be transferred to the task provider in an appropriate format directly representing a solution for the specified task.

In a further embodiment, the method further comprises receiving the definitions of task categories and compliant input data from providers or suppliers of the interactive processes. The definitions of task categories and compliant input data may be received from any third party providing or supplying interactive processes. The definitions of task categories may include one or more categories of tasks suitable for being handled by the interactive process, mapping of task categories to actions or activities within the interactive process and suitable data formats for input data. This enables an extensibility and flexibility of the approach with regard to new developments of interactive processes. Furthermore, development of interactive processes can be optimized with respect to embedding of tasks, for example by directly supporting interfaces for respective input data. For example, new game developments can be optimized with respect to one or more embodiments of the present disclosure by directly supporting interfaces and utilizing generalized meta formats for crowdsourcing tasks by gamification.

In yet another embodiment, the tasks are related to analysis and/or processing of image data, including one, two, three or multi-dimensional image data.

Individual processing of the method according to one or more embodiments of the present disclosure may be performed by a processing entity, such as one or more modules, an engine, a processor or a dedicated processor, such as on dedicated hardware. Furthermore, respective processing steps may correspond to instructions, which may be stored in memory of the processor or dedicated processor, which may be configured according to the stored instructions to perform the method according to one or more embodiments of the present disclosure.

According to another aspect of the present disclosure, a computer-readable medium having instructions stored thereon is provided, such as one or more non-transitory computer-readable media, wherein said instructions, in response to execution by a computing device, cause said computing device to automatically perform a method for distributing tasks according to one or more embodiments of the present disclosure. In particular, the instructions may cause the computing device to select at least one interactive process according to at least one task, transfer input data related to the at least one task to at least one server associated with the at least one interactive process, the input data to be distributed to one or more clients configured to execute entities of the at least one interactive process, collect from the at least one server associated with the at least one interactive process one or more results of processing of respective entities of the at least one interactive process based on the input data on the one or more clients or at least some of the clients, and provide output data for the at least one task based on the collected one or more results.

According to yet another aspect of the present disclosure, a system for distributing tasks comprises one or more computing devices implementing one or more modules configured to select at least one interactive process according to at least one task, transfer input data related to the at least one task to at least one server device associated with the at least one interactive process, the input data to be distributed to one or more client devices configured to execute entities of the at least one interactive process, collect from the at least one server device associated with the at least one interactive process one or more results of processing of respective entities of the at least one interactive process based on the input data on the one or more client devices or at least some of the client devices, and provide output data for the at least one task based on the collected one or more results.

The one or more modules can be implemented using an engine, such as a task distribution engine (TDE). The system or the TDE can be connected via a first network to one or more task providers which are configured to submit respective tasks and related sets of data to the system or the TDE. The system or the TDE may access, via a second network, which may be the same as or different from the first network, one or more server devices associated with the interactive process, such as one or more server devices of one or more providers of the interactive processes, in order to submit the input data for processing by individual entities of the interactive processes, wherein each server device may be connected via a third network, which may be the same as or different form the first and/or second network, with a plurality of the client devices executing entities of respective interactive processes.

According to one embodiment, the one or more modules are further configured to receive the at least one task and a related set of data from a task provider, and transform at least a part of the set of data into respective input data compliant with one of the selected at least one interactive process. The task provider may represent and/or operate an apparatus and/or a computing device or a processing resource on an apparatus and/or a computing device, which may be capable of providing task definitions and related sets of data via network, such as the first network.

In yet another embodiment, the one or more modules are further configured to anonymize the set of data.

According to one embodiment, the one or more modules are further configured to automatically determine a category of the at least one task, wherein the at least one interactive process is selected according to the determined category.

In yet another embodiment, the system further comprises a data base including entries, each entry specifying one or more of at least one category of tasks, at least one interactive process capable of handling tasks of the at least one category, and at least one indication for transforming data such that it can be processed by a respective interactive process.

In yet another embodiment, the at least one interactive process is selected according to a category of the at least one task and based on at least one of available resources and a level of quality of results of comparable tasks previously processed by entities of the interactive process or individual clients having executed entities of the interactive process for a different task at least once in the past.

In yet another embodiment, one or more modules are further configured to transform the collected one or more results back into a format compliant with the at least one task, and provide the transformed results as the output data of the at least one task to the task provider.

According to a further embodiment, the system further comprises an interface configured to receive definitions of task categories and compliant input data from providers of the interactive processes. The interface may be implemented by one of the one or more modules or may represent a dedicated functionality of the one or more computing devices, which can be implemented in hardware, software or a combination thereof.

According to yet another aspect of the present disclosure, an apparatus is provided, comprising a communication interface configured to transmit at least one task and related data to a system and receive, from the system, a solution of the at least one task for the related data. The system may be configured to assign the task to at least one interactive process and to transfer input data related to the data of the task to at least one server associated with the at least one interactive process for distribution to one or more client devices configured to execute entities of the at least one interactive process. The solution is based on one or more results of respective entities of the at least one interactive process according to the input data on the one or more client devices or at least some of the one or more client devices.

In one embodiment, the apparatus may be connected to the system according to one or more embodiments of the present disclosure. Preferably, the apparatus may be operated by a task provider in order to provide tasks and respective sets of data.

The present disclosure allows for a solution of various tasks, such as medical and non-medical image processing, computer vision, and pattern recognition tasks, or more general signal processing tasks, using established interactive processes having a high popularity, such as computer games using the concepts of playsourcing. The disclosure may be directed at automatic classification and context sensitive assignment of various tasks to generic concepts of interactive processes. This enables an embedding of various tasks and respective associated data into existing and popular interactive processes in a re-usable manner, which enables a simultaneous, fast and cheap solution of tasks by individuals which are willing to execute respective interactive processes.

It is to be understood that components of the system or the apparatus according to one or more embodiments of the present disclosure may be configured to perform processing steps according to the method for distributing tasks according to one or more embodiments of the present disclosure, and the method for distributing tasks according to one or more embodiments of the present disclosure may include processing steps corresponding to functionality or processing of components of the system or apparatus according to one or more embodiments of the present disclosure, in any combination.

### BRIEF DESCRIPTION OF THE DRAWINGS

Specific features, aspects and advantages of the present disclosure will be better understood with regard to the following description and accompanying drawings, where:

FIG. 1 illustrates a schematic diagram of a system according to an embodiment of the present disclosure;

FIG. 2 shows a flow chart of a method according to an embodiment of the present disclosure; and

FIG. 3a to FIG. 3c show examples of data related to a task, processing of an interactive process, and a result representing a solution of the task, respectively, according to one embodiment of the present disclosure.

### DETAILED DESCRIPTION

In the following description, reference is made to drawings that show by way of illustration various embodiments of the present disclosure. Also, various embodiments will be described below by referring to several examples. It is to be understood that the embodiments may include changes in design and structure without departing from the scope of the claimed subject matter.

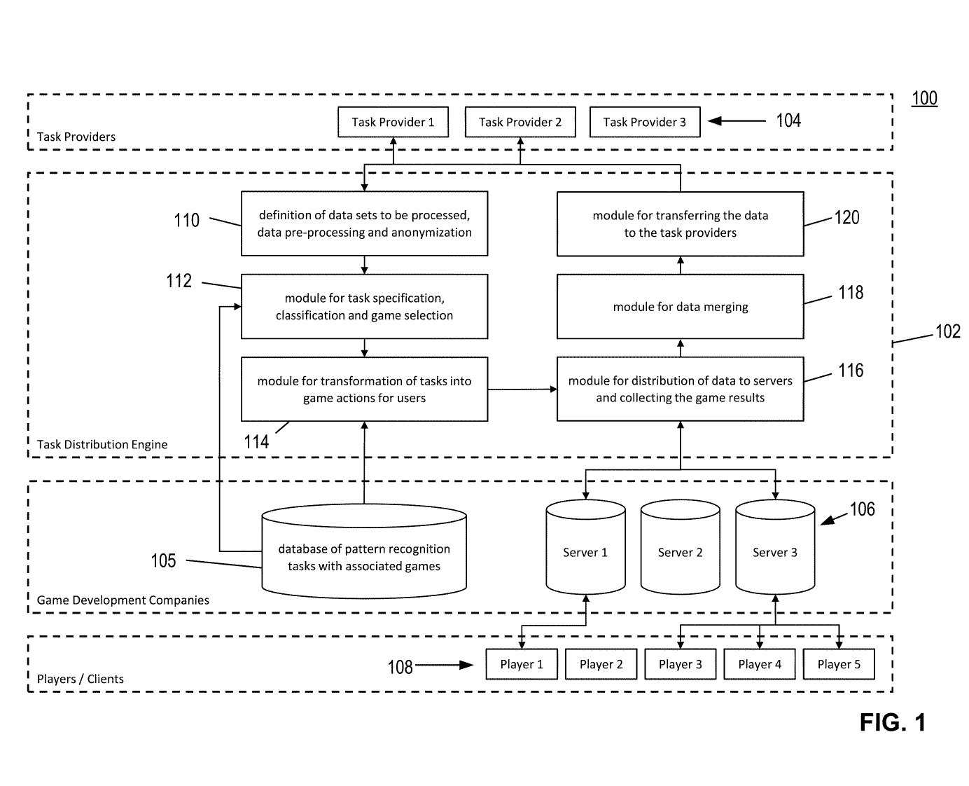

FIG. 1 shows a schematic diagram of a system according to an embodiment of the present disclosure. The system 100 may be a computer system comprising one or more computing devices, which may implement a task distribution engine 102. The system 100 may enable a distribution and solution of tasks based on embedding tasks into existing game applications.

The task distribution engine 102 may be connected via a network to a plurality of task providers 104, which may supply tasks and respective sets of data to the task distribution engine 102. The task distribution engine 102 may further be connected to a database 105 and a plurality of servers 106 via said network or a different network. The servers 106 may be controlled by a provider of the system 100 or the task distribution engine 102, or a provider or supplier of a game application, or both.

Each server 106 may maintain a network of players 108 currently utilizing a respective game application. Each player 108 may correspond to a client or client device, which may be a computing device, a console, a smartphone or the like. Accordingly, each server 106 may implement an online service for the game application, such as a social network dedicated to games of a provider or supplier. The players 108 may register with an individual server 106 in order to connect to the server 106, and/or receive code representing the game, updates or upgrades of the game. Furthermore, the players 108 may utilize the server 106 to connect to other players 108. The server 106 may also supply any further data to the players 108 which could be used to configure, alter, track, monitor and/or analyze execution of the game by the player 108.

The provider of the game may maintain the data base 105, as shown by the dotted line. However, similar to the servers 106 it is to be understood that the data base 105 can also be maintained by the task distribution engine 102 independent of the providers or suppliers of the games. In this case, the providers or suppliers of the games can submit respective entries for the database 105 via the task distribution engine 102 or another dedicated interface (not shown) of the system 100.

The task distribution engine 102 may be configured to receive tasks and respective data sets from individual task providers 104 via a first module 110. The first module 110 may allow the task providers 104 to specify the data to be processed as well as the task to be conducted, such as analysis and/or processing of image data, audio data, sensor data, descriptive data and the like. For example, the task may be directed at data processing or analysis, such as segmentation, detection, classification and other tasks in the areas of computer vision, pattern recognition, or image processing and the like. For example, the task may address segmentation of an organ from computed tomography data. The first module 110 may further pre-process the specified data sets, for example, by anonymizing the data sets and adjusting the resolution of data samples, normalizing the data and the like.

The data processed by the first module 110 may be further supplied to a second module 112, which may classify the tasks with regard to available games or game concepts. The second module 112 may access the data base 105, which could include entries referring to generic descriptions of games and game concepts. The descriptions may comprise, however, are not limited to a) a type of a game or a type of a game concept, such as one or more of an arcade game, a role-playing game, a strategy game, a simulation game, a sports game and the like and similar genres of games, b) valid tasks which can be processed using the game concept of the game application, and/or c) data formats understood by the game application, into which the data sets are to be transformed. Based on the class or category of the task, the second module 112 may select a game or game concept for embedding the task.

In a third module 114 of the task distribution engine 102, the original task could be transformed into actions or activities within game applications of the game concept selected by the second module 112. The third module 114 may use the pre-processed data together with the selected game concept to perform further concept-specific processing steps in order to provide transformed data together with respective interaction concepts for the selected game concept, such as mapping the task to game actions of the selected game.

The task distribution engine 102 may further comprise a fourth module 116, which may assign the tasks and respective data to the servers 106, individual game applications and/or individual players 108, in any combination, according to available resources, such as a number of games corresponding to the selected game concept, a number of available (online) clients or players 108, available bandwidth and the like. This assignment may also be based on quality metrics computed from previously completed tasks of individual players 108. This allows for an optimal exploitation of resources for embedding and solving individual task. This further allows to assign tasks with specific quality demands to players 108 who have proven to provide results of particular quality. The fourth module 116 may supply respective input data to the assigned servers 106, which may distribute the input data to individual players or clients 108 which may include one or more assigned players 108. The servers 106 may utilize the knowledge of the network of players 108, as, for example, defined by a social network directed at a multiplayer game or a role-playing game. The assigned server 106 may gather any output or results of processing of the game by the players 108. The fourth module 116 may collect respective results from the assigned servers 106.

The task distribution engine 102 may further comprise a fifth module 118, which may merge the results and analyze the results with regard to a level of quality. For example, the results may be statistically analyzed and merged by the fifth module 118.

The merged results may be provided to a sixth module 120 of task distribution engine 102, which may transform the results back into a suitable or desired format by the task providers 104 and may provide the result to the respective task provider 104.

Even though the system 100 has been described with regard to game applications, the present disclosure is not limited to game applications. Rather, any interactive process executable on individual clients can be used to solve tasks embedded within the interactive process, such as office applications, networking applications, communication applications or any kind of executable program code, which allows for an interaction of users with the program code on a client and which enables a configuration of the program code using the input data derived from the task.

The system 100 may represent a dedicated system layout and communication structure which provides for an efficient distribution and solution of tasks, which is flexible with regard to both, a number of task providers 104 and a number of providers or suppliers of interactive processes as well as players 108, which can flexibly connect to the system 100 in order to provide tasks and respective data and/or contribute to solutions of embedded tasks.

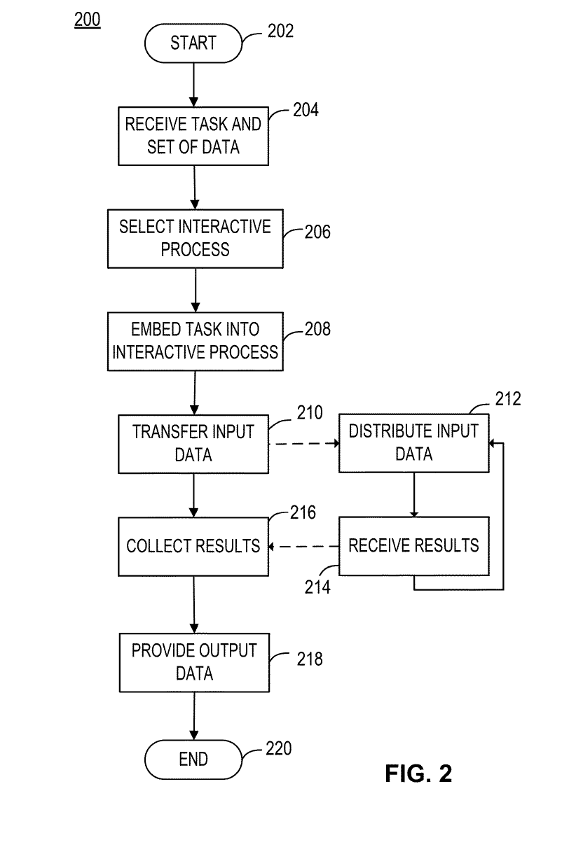

FIG. 2 shows a flow chart of a method for distributing tasks according to one embodiment of the present disclosure. The method 200 may start in item 202 and proceed with receiving a task and a related set of data from a task provider, in item 204. The set of data can be pre-processed and, for example, be anonymized.

In item 206, one or more interactive processes or a concept of interactive processes from a plurality of existing interactive processes may be selected according to the at least one task. The selection may be based on a category of the task, which can be automatically determined.

The method 200 may proceed with item 208, where the task is embedded into the concept of the selected interactive process. For example, the set of data or parts of the set of data received in item 204 can be transformed into a format compliant with the selected interactive process or concept and the task can be mapped on interactions or activities within the interactive process or concept. The results of processing of item 208 may define input data for the selected interactive process or an interactive process according to the selected concept. The input data may include the transformed data and/or the mapping of the task to actions or activities within the interactive process or concept.

The input data may be transferred to a server associated with the selected interactive process, or to one or more servers associated with interactive processes according to the selected concept, as indicated by the dotted line between items 210 and 212.

The server or the one or more servers may be connected to a plurality of clients which are configured to execute entities of the interactive processes. Responsive to receipt of new input data, the server may distribute the input data to at least some of the clients in item 212, for configuration and execution of the interactive processes based on the input data. Processing on the server may proceed with item 214, where results of completed interactive processes based on the input data are received from the individual clients. Processing on the server may reiterate with item 212, where the server may continue listening for new input data.

The method 200 may proceed with item 216, wherein the results received in item 214 are collected and post-processed in order to generate output data, which are provided in item 218 back to the task provider.

The method 200 may end in item 220. Yet, method 200 may also re-iterate with item 204 and wait for further tasks and sets of data.

The method 200 represents a crowdsourcing approach for solving various tasks which are embedded into existing interactive processes. By embedding the tasks into existing interactive processes, such as games, entertainment applications, office applications and the like, the task can be solved by established communities of users of the interactive processes, without requiring a change of a concept of the interactive process. Rather, the solution of the task embedded in the interactive process can be regarded as a by-product of an execution of the interactive process.

Individual processing of the method 200 may be performed on the system 100 as shown in FIG. 1. For example, processing can be mapped on the modules 110 . . . 120 of the task distribution engine 102 of the system 100. Likewise, processing items 212, 214 can be performed on the servers 106 of the system 100.

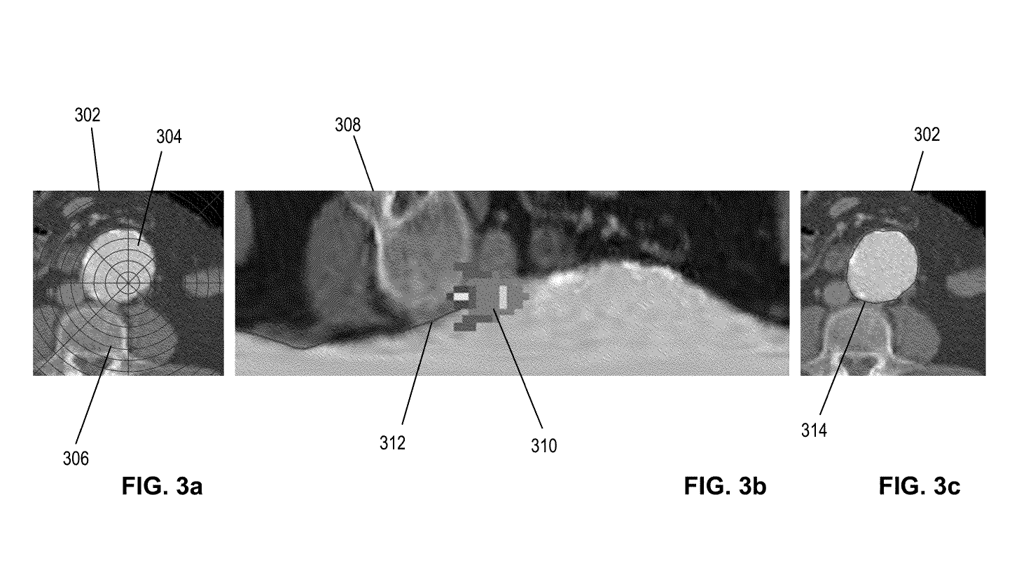

FIGS. 3a to 3c show examples of data related to a task, processing of a game application, and a solution of the task, respectively, according to one embodiment of the present disclosure.

FIG. 3a shows image data 302 of an organ 304, which can be obtained by medical imaging procedures, such as MRI, CT, sonography, and the like. The image 302 may be a cross section of a volume data set representing a scan of the organ 304. A task may be to segment the organ 304, which is shown in the image 302 in a light grey value.

A task distribution system, such as the system 100 of FIG. 1, may receive the task including the image 302 as well as further image data of individual patients. The image 302 may be transformed by resampling the original image 302 with regard to a polar grid 306 in order to provide resampled data for the canvas or texture of an arcade game. The task of object segmentation may be further mapped onto interactions and activities within the game, which are a part of the workflow of the game. For example, game players may be required to trace a border within an image or solving a puzzle in the context of the current game. Those challenges are frequently arising within adventures or role-playing games, where players appreciate solving them.

As shown in FIG. 3b, the transformed image 302 of FIG. 3a and the mapping of the task may be used to configure a game application executed on a client, such as one of the clients 108 of FIG. 1. The player may control a character 310 and navigate the character along individual paths. The player may be asked to trace a border on a texture 308 using character 310. The game application may be configured, such that the texture 308 may correspond to the transformed image 302. The game application may monitor a current performance of the player, as indicated by line 312.

It is to be understood that the game application and concept shown in FIG. 3b is an example and the present invention is not limited to the described game concept. For example, as shown in FIGS. 3a and 3b, the transformed texture 308 may still resemble the image 302. However, the tasks and respective data may also be indirectly included into a game such that players may solve challenges on a different meta-level, which may be directly integrated into the game workflow, where image data may be transformed into a different representation. However, any kind of input data, such as image data, acoustic data, measurement series of any sensor or descriptive data can be used as original data of a task and may be transformed into data of another format or representation, which could likewise be image data, acoustic data, sensor data or descriptive data or the like, in any combination.

For example, image data could be transformed into audio data, which are provided to a player as acoustic output and which can be used to automatically solve a task within an existing game.

In yet another example, based on initial image data, race tracks can be generated automatically, while players may follow a specific height level to finish a game level. The specific level of height could represent, in such an exemplary context, an isoline or surface of an object contour.

The results of a separation of a horizon or boundary via a flight level may be tracked, as represented by the line 312, and further processed. As shown in FIG. 3c, the line 312 and/or other similar results generated on the same or different client device may be back transformed and merged to form a result 314. For example, line 312 could be back transformed into a Cartesian coordinate system and overlaid onto the original image 302.

Examples and embodiments of the present disclosure may refer to a solution of computer vision and pattern recognition tasks via gamification and playsourcing, where game concepts and technology are used in non-game contexts represented by individual tasks, and where contributions are gathered from a community of game players. Preferably, the visual and cognitive tasks are integrated or embedded into respective computer games in order to use player interactions for solution of classical computer vision and pattern recognition tasks. Accordingly, tasks can be integrated into existing computer games or combined with existing game concepts.

Even though examples of the present disclosure have been described with regard to computer vision and pattern recognition tasks and/or with regard to medical data, it is to be understood that the present invention is not restricted to computer vision and pattern recognition tasks and/or medical data. Rather, embodiments of the present disclosure can be applied in any suitable area with any tasks and data types, which tasks can be formalized in order to enable automatic determination of a category of the task and which data allow for a transformation of the data into a format suitable for execution by interactive processes.

While some embodiments have been described in detail, it is to be understood that aspects of the disclosure can take many forms. In particular, the claimed subject matter may be practiced or implemented differently from the examples described, and the described features and characteristics may be practiced or implemented in any combination. The embodiments shown herein are intended to illustrate rather than to limit the invention as defined by the claims.

1. A method for distributing tasks, comprising:
selecting at least one interactive process according to at least one task;
transferring input data related to the at least one task to at least one server associated with the at least one interactive process, the input data to be distributed to one or more clients configured to execute entities of the at least one interactive process;
collecting from the at least one server associated with the at least one interactive process one or more results of processing of respective entities of the at least one interactive process based on the input data on the one or more clients; and
providing output data for the at least one task based on the collected one or more results.

2. The method of claim 1, further comprising receiving the at least one task and a related set of data, and transforming at least a part of the set of data into the input data compliant with the selected at least one interactive process.

3. The method of claim 2, wherein said transforming includes anonymizing the set of data.

4. The method of claim 1, further comprising automatically determining a category of the at least one task, wherein the at least one interactive process is selected according to the determined category.

5. The method of claim 4, further comprising querying a data base including entries, each specifying at least one category of tasks and at least one interactive process capable of handling tasks of the at least one category.

6. The method of claim 1, wherein the at least one interactive process is selected based on available resources.

7. The method of claim 6, wherein the available resources are based on a number of available clients for executing entities of the at least one interactive process.

8. The method of claim 1, wherein the at least one interactive process is selected based on a level of quality of results of comparable tasks previously processed by entities of the at least one interactive process.

9. The method of claim 1, further comprising transforming the collected one or more results back into a format compliant with the at least one task, and providing the transformed results as the output data of the at least one task.

10. The method of claim 1, further comprising receiving definitions of task categories and compliant input data from providers of the interactive processes.

11. The method of claim 1, wherein the tasks are related to analysis and/or processing of image data, including one, two, three or multi-dimensional image data.

12. The method of claim 1, wherein one or more of the interactive processes are game applications.

13. The method of claim 2, wherein said transforming includes transforming data from a medical image format into a native game format.

14. A system for distributing tasks, comprising one or more computing devices implementing one or more modules configured to:
select at least one interactive process according to at least one task;
transfer input data related to the at least one task to at least one server device associated with the at least one interactive process, the input data to be distributed to one or more client devices configured to execute entities of the at least one interactive process;
collect from the at least one server device associated with the at least one interactive process one or more results of processing of respective entities of the at least one interactive process based on the input data on the one or more client devices; and
provide output data for the at least one task based on the collected one or more results.

15. The system of claim 14, wherein the one or more modules are further configured to receive the at least one task and a related set of data from a task provider, and transform at least a part of the set of data into the input data compliant with the selected at least one interactive process.

16. The system of claim 14, further comprising a data base including entries, each entry specifying one or more of at least one category of tasks, at least one interactive process capable of handling tasks of the at least one category, and at least one indication for transforming data such that it can be processed by a respective interactive process.

17. The system of claim 14, wherein the at least one interactive process is selected according to a category of the at least one task and based on at least one of available resources and a level of quality of results of comparable tasks previously processed by entities of the at least one interactive process.

18. The system of claim 15, wherein the one or more modules are further configured to transform the collected one or more results back into a format compliant with the at least one task, and provide the transformed results as the output data of the at least one task to the task provider.

19. The system of claim 14, further comprising an interface configured to receive definitions of task categories and compliant input data from providers of the interactive processes.

20. An apparatus comprising:
a communication interface configured to transmit at least one task and related data to a system and receive, from the system, a solution of the at least one task for the related data,
wherein the task is assigned, by the system, to one or more interactive processes and input data related to the data of the task are transferred, by the system, to one or more servers associated with the one or more interactive processes for distribution to one or more client devices configured to execute entities of at least one of the one or more interactive processes, and
wherein the received solution is based on one or more results of respective entities of the at least one interactive process according to the input data on the one or more client devices.
